(19) United States
(12) Patent Application Publication
(10) Pub. No.: US 2026/0213886 A1
(43) Pub. Date: Jul. 23, 2026

(54) Communication method and OMAMRC system with a selection during retransmissions taking into account a single conditional exchange of CSI

(71) Applicant: ORANGE, ISSY LES MOULINEAUX (FR)

(72) Inventors: Ali AL KHANSA, Chatillon (FR); Raphaël VISOZ, Chatillon (FR)

(21) Appl. No.: 19/140,124

(22) PCT Filed: Dec. 19, 2023
(86) PCT No.: PCT/EP2023/086710

§ 371 Date: Jun. 17, 2025

(30) Foreign Application Priority Data
Dec. 21, 2022 (FR) FR2214097

(51) Int. Cl. H04L 1/1812; H04L 1/22; H04L 5/16

(52) U.S. Cl. CPC H04L 1/1819; H04L 1/22; H04L 5/16

(57) ABSTRACT

A communication method with transmission of a frame transporting messages, intended for a telecommunication system having N nodes including M sources (S i iϵ{1, . . . , M}) and N−M relays, where N≥M≥2, and one destination. The transmission includes a maximum number of M+T max time intervals per transmitted frame, distributed between a first phase and a second phase. The selection of the sources to be assisted during the second phase takes into account the numbers of retransmission intervals in order for the destination to decode the sources not yet correctly decoded and a sum of throughputs assigned to the sources. These numbers are first estimated and then determined following a conditional exchange of quality information of the indirect channels.

### FIELD OF THE INVENTION

The present invention relates to the field of digital communications. In this field, the invention more specifically relates to the transmission of coded data within a telecommunication system defined by at least two sources and a destination with relaying by at least one node that can be one of the sources or a relay in case one or more relays complete the system.

It is understood that a relay does not have a message to be transmitted. A relay is a node dedicated to relaying messages from sources, while a source has its own message to be transmitted and can also, in some cases, relay the messages from the other sources, i.e., the source is said to be cooperative in this case.

Many relaying techniques exist, namely: “amplify and forward”, “decode and forward”, “compress and forward”, “non-orthogonal amplify and forward”, “dynamic decode and forward”, etc.

The invention notably, but not exclusively, applies to the transmission of data via mobile networks, for example for real-time applications, or via sensor networks, for example.

Such a sensor network is a multi-user network, made up of several sources, several relays and a recipient using a time orthogonal multiple access scheme of the transmission channel between the relays and the sources, denoted OMAMRC (Orthogonal Multiple Access Multiple Relay Channel).

### PRIOR ART

The considered telecommunication system illustrated in FIG. 1 has N nodes and a destination and implements a time orthogonal multiple access scheme of the transmission channel that is applicable between the N nodes. The N nodes include M sources and N−M=L relays. The maximum number of time slots per transmitted frame is M+Tₘₐₓ, with M slots allocated during a first phase to the successive transmission of the M sources and T_{used}≤Tₘₐₓ slots for one or more cooperative transmissions allocated during a second phase to one or more nodes selected by the destination according to a selection strategy.

Such a telecommunication system implementing a selection strategy during the second phase is known from article [1]. The described telecommunication system is such that each of the sources can operate at different times or exclusively as one source, or as a relay node. The term node equally covers a relay and a source acting as a relay node or as a source. A relay differs from a source because it does not have a message to transmit that is specific thereto, i.e., it only retransmits messages originating from other nodes.

The links between the various nodes of the system are subject to slow fading and Gaussian white noise. Knowledge of all the system links (CSI: Channel State Information) by the destination is not available. Indeed, the links between the sources, between the relays, between the relays and the sources cannot be directly seen by the destination and in order to be known by the destination an exchange of information is required between the sources, the relays and the destination. In order to limit the cost of feedback overhead, shown as dashed lines in FIG. 1, only information concerning the channel distribution/statistic (CDI: Channel Distribution Information) of all the links, for example average quality (for example average SNR, average SINR) of all the links, is assumed to be known by the destination for the purpose of determining the rates allocated to the sources.

The link adaptation is said to be slow, i.e., before any transmission, the destination allocates initial rates to the sources knowing the distribution of all the channels (CDI: Channel Distribution Information). In general, it is possible to feed back to the CDI distribution based on knowledge of the average SNR or SINR of each system link.

The transmissions of the source messages are formatted into frames, during which the CSIs of the links are assumed to be constant (slow fading assumption). It is assumed that the rate allocation does not change for several hundred frames; it only changes with changes in the CDI.

The method distinguishes three phases: an initial phase and, for each frame to be transmitted, a 1^{st} phase and a 2^{nd} phase. A frame is transmitted in two phases, which are optionally preceded by an additional phase, called initial phase.

During the initialization phase, the destination determines an initial rate Rᵢ for each source Sᵢ while taking into account the average quality (for example, SNR) of each of the system links.

The destination estimates the quality (for example, SNR) of the direct links: source to destination and relay to destination according to known techniques based on the exploitation of reference signals. The quality of the source-source, relay-relay and source-relay links is estimated by the sources and the relays by exploiting reference signals, for example. The sources and the relays transmit the average qualities of the links to the destination. This transmission occurs before the initialization phase. With only the average value of the quality of a link being taken into account, it is refreshed over a long time scale, i.e., over a time period that allows fast variations (fast fading) of the channel to be averaged. This time is of the order of the time required to travel several tens of wavelengths of the frequency of the transmitted signal for a given speed of a node of the system. The initialization phase occurs every 200 to 1000 frames, for example. The destination feeds back the initial rates it has determined to the sources via a return path. The initial rates remain constant between two occurrences of the initialization phase.

During the first phase, the M sources successively transmit their message during the M time slots, respectively using modulation and coding schemes determined from the initial rates.

During this phase, the number N₁ of channel uses (i.e., resource element according to 3GPP terminology) is set and is identical for each source.

The mutually independent sources broadcast their sequence of coded information during the first phase in the form of a message for the attention of a single recipient. Each source broadcasts its message with its initial rate. The destination sends each source its initial rate via control channels with very limited rate. Thus, during the first phase, the sources each in turn transmit their respective message during time slots each dedicated to a source.

The sources other than that which transmits, and optionally the relays, of the half-duplex type, receive the successive messages from the sources and decode them.

During the second phase, the destination selects, for the current slot t, a single node from among the sources and the relays to cooperate. This node randomly selects the source that it assists from among the source it has correctly decoded and that the destination has not yet correctly decoded by transmitting a redundancy for the message from this source.

This phase lasts for a maximum Tₘₐₓ number of time slots. During this phase, the number N₂ of channel uses is set and is identical for each of the selected (source and relay) nodes.

This article teaches about control signals that involve, for the destination, broadcasting M bits that indicate its set of correctly decoded sources for the slot t−1, for the nodes that have correctly decoded a source that the destination has not yet correctly decoded, transmitting a signal over a dedicated unicast channel and, for the others, remaining silent and, finally, for the destination, broadcasting the result of its selection according to the selected selection strategy.

The protocol followed by the exchanges limits signaling-related overhead, while maximizing the average spectral efficiency (utility metric) within the considered system, subject to compliance with an individual quality of service (QoS) per source, but the protocol does not forecast which sources can be correctly decoded by the destination or to best use the available time during the 2^{nd} phase to decode a maximum number of sources.

### Main Features of the Invention

The aim of the present invention is a communication method with transmission of a frame conveying at least one message intended for a telecommunication system comprising N nodes including M sources and N−M relays, N≥M≥2, and a destination, the nodes operating in half-duplex mode, with orthogonal multiple access to the transmission channel between the N nodes and the destination, with a maximum number of M+Tₘₐₓ time slots per transmitted frame distributed between a 1^{st} phase and a 2^{nd} phase. The message from a source is coded before transmission according to incremental redundancy type coding that generates several redundancies. The 1^{st} phase includes M slots respectively allocated to the successive transmissions of M initial redundancies of the M messages from the M sources. The 2^{nd} phase includes at least one retransmission slot for a transmission from nodes with correct knowledge of the same source, such that these nodes simultaneously transmit the same redundancy of the message from the same source not yet correctly decoded by the destination during the same retransmission slot. The transmission channel encompasses the transmission channels, called direct channels, between the nodes and the destination and the transmission channels, called indirect channels, between the nodes. The method comprises setting a remaining time during the 2^{nd} phase to Tₘₐₓ and determining a set Â of sources not yet correctly decoded, taking into account numbers of retransmission slots so that the destination can decode these sources in the remaining time, with the sources, called sources to be assisted, of the set Â being such that the sum of the number of retransmission slots thereof is less than or equal to the remaining time.

The method implemented by the destination comprises:
determining numbers of retransmission slots based on knowledge of rates assigned to the sources and on at least quality information of the various direct channels between the sources and the destination obtained from the transmissions that occurred during the 1^{st} phase, with these determined numbers of slots being at least sufficient for the destination to decode these sources;
receiving redundancies transmitted by the nodes with correct knowledge of the sources to be assisted, during the determined numbers of slots, so that the destination decodes these sources, and updating the remaining time after each retransmission slot; and
subject to the set Â being empty and to at least one not correctly decoded source remaining and the remaining time being non-zero, determining numbers of retransmission slots based on knowledge of the rates assigned to these sources and on knowledge of a quality of the various direct transmission channels and of the various indirect transmission channels, with these determined numbers of slots being necessary and sufficient for the destination to decode the sources i not yet correctly decoded, and updating the set Â while taking into account necessary and sufficient numbers of slots.

The destination estimates a sufficient number of retransmission slots for decoding a source not yet correctly decoded based on knowledge of the rate allocated to this source and on at least the quality information CSIⱼ of the direct channel. A source is assisted for at most the sufficient number of retransmission slots by transmitting a redundancy during the 2^{nd} phase by the one or more nodes with correct knowledge of this source, i.e., the transmitted redundancy assists the destination in correctly decoding this source.

The estimates of the numbers of retransmission slots for the various sources not yet correctly decoded may not be sufficient for optimizing the use of the remaining time and correctly decoding a maximum number of sources. A single transmission of quality information CSIⱼ of the indirect channels is then conditionally triggered in order for the destination to exactly determine the numbers of retransmission slots that are necessary and sufficient for decoding the sources not yet correctly decoded. Knowing these exact necessary and sufficient numbers of slots, the destination can then update the set Â of sources to be assisted.

The invention has the advantage of limiting signaling overhead only in some cases, of not unnecessarily transmitting if no source can be assisted in the remaining time and of optimizing the number of sources that can be correctly decoded.

A further aim of the invention is a communication method with transmission of a frame conveying at least one message implemented by a telecommunication device intended for a telecommunication system comprising N nodes including M sources and N−M relays, N≥M≥2, and a destination, the device forming one of the sources, the nodes operating in half-duplex mode, with orthogonal multiple access to the transmission channel between the N nodes and the destination, with a maximum number of M+Tₘₐₓ time slots per transmitted frame distributed between a 1^{st} phase and a 2^{nd} phase, with the message from a source having been coded before transmission according to incremental redundancy type coding that generates several redundancies, the 1^{st} phase includes M slots respectively allocated to the successive transmissions of M initial redundancies of the M messages from the M sources and the 2^{nd} phase includes at least one retransmission slot for a transmission from nodes with correct knowledge of the same source, such that these nodes simultaneously transmit the same redundancy of the same message from the same source not yet correctly decoded by the destination during the same retransmission slot, with the transmission channel encompassing the transmission channels, called direct channels, between the nodes and the destination and the transmission channels, called indirect channels, between the nodes with a remaining time being set during the 2^{nd} phase to Tₘₐₓ and a set Â of sources not yet correctly decoded being determined, taking into account numbers of retransmission slots so that the destination can decode these sources in the remaining time, with the sources, called sources to be assisted, of the set Â being such that the sum of the number of retransmission slots thereof is less than or equal to the remaining time, wherein the method comprises:
transmitting a first redundancy of a message from the device during the 1^{st} phase;
transmitting, during a retransmission slot of the 2^{nd} phase, a second redundancy of the message from a source of the set Â if the device has correct knowledge of this source;
conditional exchange of control with the destination, during which the device transmits quality information of the indirect links of the device with the other nodes.

A further aim of the invention is a telecommunication device for transmitting a frame conveying at least one message intended for a telecommunication system comprising N nodes including M sources and N−M relays, N≥M≥2, and a destination, the nodes operating in half-duplex mode, with orthogonal multiple access to the transmission channel between the N nodes and the destination, with a maximum number of M+Tₘₐₓ time slots per transmitted frame distributed between a 1^{st} phase and a 2^{nd} phase, with the message from a source having been coded before transmission according to incremental redundancy type coding that generates several redundancies, the 1^{st} phase includes M slots respectively allocated to the successive transmissions of M initial redundancies of the M messages from the M sources and the 2^{nd} phase includes at least one retransmission slot for a transmission from nodes with correct knowledge of the same source (Sᵢ), such that these nodes simultaneously transmit the same redundancy of the same message from the same source not yet correctly decoded by the destination during the same retransmission slot, with the transmission channel encompassing the transmission channels, called direct channels, between the nodes and the destination and the transmission channels, called indirect channels, between the nodes with a remaining time being set during the 2^{nd} phase to Tₘₐₓ and a set Â of sources not yet correctly decoded being determined, taking into account numbers of retransmission slots so that the destination can decode these sources in the remaining time, with the sources, called sources to be assisted, of the set Â being such that the sum of the number of retransmission slots thereof is less than or equal to the remaining time, the device that corresponds to one of the sources comprises at least one microprocessor, a memory, a transmitter and a receiver, the transmitter comprises a coder implementing incremental redundancy type coding that generates several redundancies of the same message to be transmitted, the device is such that:
the transmitter is adapted to transmit a first redundancy of a message from the device during the 1^{st} phase;
the transmitter is also adapted to transmit, during a retransmission slot of the 2^{nd} phase, a second redundancy of the message from a source of the set Â if the device has correct knowledge of this source;
the transmitter and the receiver being adapted for a conditional exchange of control with the destination, during which the device transmits quality information of the indirect links of the device with the other nodes.

A further aim of the invention is a base station intended for a telecommunication system comprising N nodes including M sources and N−M relays, N≥M≥2, and a destination, the nodes operating in half-duplex mode, with orthogonal multiple access to the transmission channel between the N nodes and the destination, with a maximum number of M+Tₘₐₓ time slots per transmitted frame distributed between a 1^{st} phase and a 2^{nd} phase, with the message from a source having been coded before transmission according to incremental redundancy type coding that generates several redundancies, the 1^{st} phase includes M slots respectively allocated to the successive transmissions of M initial redundancies of the M messages from the M sources and the 2^{nd} phase includes at least one retransmission slot for a transmission from nodes with correct knowledge of the same source, such that these nodes simultaneously transmit the same redundancy of the same message from the same source not yet correctly decoded by the destination during the same retransmission slot, with the transmission channel encompassing the transmission channels, called direct channels, between the nodes and the destination and the transmission channels, called indirect channels, between the nodes with a remaining time being set during the 2^{nd} phase to Tₘₐₓ and a set Â of sources not yet correctly decoded being determined, taking into account numbers of retransmission slots so that the destination can decode these sources in the remaining time, with the sources, called sources to be assisted, of the set Â being such that the sum of the number of retransmission slots thereof is less than or equal to the remaining time, the base station corresponding to the destination comprises a decoder, a transmitter, a receiver, a microprocessor, such that:
during the 1^{st} phase the receiver is able to successively receive the M first redundancies of the M messages from the M sources;
the microprocessor is able to determine numbers of retransmission slots based on knowledge of rates assigned to the sources and on at least quality information of the various direct channels between the sources and the destination obtained from the transmissions that occurred during the 1^{st} phase, with these determined numbers of slots being at least sufficient for the destination to decode these sources;
the receiver is also able to receive redundancies transmitted by the nodes with correct knowledge of the sources to be assisted, during the determined numbers of slots, so that the base station decodes these sources;
the microprocessor is also able to update the remaining time after each retransmission slot;
the microprocessor is also able to determine numbers of retransmission slots, subject to the set Â being empty and to at least one not correctly decoded source remaining and the remaining time being non-zero, based on knowledge of the rates assigned to these sources and on knowledge of a quality of the various direct transmission channels and of the various indirect transmission channels, with these determined numbers of slots being necessary and sufficient for the destination to decode the sources not yet correctly decoded, and to update the set Â while taking into account the necessary and sufficient numbers of slots.

A further aim of the invention is a telecommunication system comprising N nodes including M sources and N−M relays, N≥M≥2, and a destination, for implementing a communication method according to another aim of the invention.

According to one embodiment, the sources of the set Â are those that maximize spectral efficiency.

According to this embodiment, the set Â of sources to be assisted comprises the sources that are not yet correctly decoded that allow spectral efficiency to be maximized. The advantage of this embodiment is that it jointly optimizes the number of sources to be decoded and the total rate achieved by the decoded sources.

According to one embodiment, the method further comprises:
broadcasting, to the N nodes for each retransmission slot, an identifier of sources taken from the set Â and doing so a number of times that is equal to the determined number of slots for the identified source.

The successive selection of the sources to be assisted by the destination can be performed either in a random or an ordered manner from among those of the set Â before reaching the maximum time Tₘₐₓ of the 2^{nd} phase. The scheduling can occur by successively selecting the sources as a function of increasing numbers of slots.

According to one embodiment, the broadcast identifier of sources is randomly selected from the sources of the set Â.

According to one embodiment, the method further comprises a comparison between the numbers of retransmission slots of the sources of the set Â so that the broadcast identifier of sources is selected while taking into account a scheduling for these numbers of retransmission slots.

According to this embodiment, the numbers of retransmission slots are classified according to their value. Furthermore, preferably, the method initially selects the source with the smallest number of retransmission slots. The same source is assisted for the duration corresponding to this number or for a shorter duration if the correct decoding thereof by the destination occurs before the end of the estimated number. The method thus successively considers the remaining sources to be correctly decoded. The method is stopped when all the sources are correctly decoded by the destination, when no source not yet correctly decoded can be assisted or when the maximum time is reached.

According to one embodiment, the method further comprises:
broadcasting, to the N nodes and in an ordered form, the set Â and the numbers of retransmission slots of the sources of the set.

According to this embodiment, the destination transmits the set Â and the numbers of retransmission slots of the sources of the set at most twice, i.e., once before and once after updating the set Â. The set Â is ordered and the numbers follow the same order. Thus, the nodes successively select the sources of the set Â by following the order and, as the succession of the numbers of slots follows the same order, they can easily make the connection between the source and the associated number of slots. The scheduling can be, for example, a function of the increasing numbers of the numbers of slots or a function of the source identifiers.

According to one embodiment, the method further comprises:
broadcasting a request to the N nodes notifying them to transmit quality information of the channels, called indirect channels, between the nodes;
receiving quality information of the indirect channels.

The request is particularly broadcast subject to the set Â being empty and to at least one source not correctly decoded remaining and the remaining time being non-zero.

According to one embodiment, if the correct decoding of a source occurs before the end of the at least sufficient number of retransmission slots, then the method updates the set Â.

Since the correct decoding of a source by the destination can occur before the end of the sufficient number of retransmission slots, this embodiment can allow another source to be assisted to benefit from the unconsumed time in order to be correctly decoded.

According to one embodiment, determining the at least sufficient numbers of retransmission slots is also based on the nodes transmitting their set of correctly decoded sources at the beginning of the 2^{nd} phase.

According to this embodiment, determining the at least sufficient numbers of retransmission slots is more precise since it can take into account quality information concerning all the direct links obtained from the nodes transmitting their set of correctly decoded sources.

According to one embodiment, during an exchange of control with the nodes at the beginning of the 2^{nd} phase, the destination sends its set of correctly decoded sources and the nodes send their set of sources correctly decoded and not yet correctly decoded by the destination and wherein determining the at least sufficient numbers of retransmission slots is also based on the nodes transmitting their set of sources correctly decoded and not yet correctly decoded by the destination.

This embodiment allows exchanges of control between the nodes and the destination to be limited, while allowing quality information to be obtained concerning direct links obtained from the nodes transmitting their set of correctly decoded sources and therefore allows the estimation of the at least sufficient numbers of retransmission slots to be refined.

According to one embodiment, if no source can be assisted in the remaining lime before the end of the 2^{nd} phase, then the transmission of the frame is interrupted before using the maximum number of retransmission slots.

The features of embodiments described above optionally can be combined with each other in order to define a new embodiment.

A further aim of the invention is each of the specific software applications on one or more information media, with said applications comprising program instructions able to implement the communication method when these applications are executed by microprocessors.

A further aim of the invention is configured memories comprising instruction codes respectively corresponding to each of the specific applications.

The memory can be incorporated into any entity or device capable of storing the program. The memory can be of the ROM type, for example a CD ROM or a microelectronic circuit ROM, or even of the magnetic type, for example a USB key or a hard disk.

Moreover, each specific application according to the invention can be downloaded from a server accessible over an Internet-type network.

The optional features set forth above within the scope of the communication method optionally can apply to the aforementioned software application and the memory.

### LIST OF FIGURES

Further features and advantages of the invention will become more clearly apparent upon reading the following description of embodiments, which are provided by way of simple illustrative and non-limiting examples, and the appended drawings, in which:

FIG. 1 is a diagram of an example of a Cooperative OMAMRC (Orthogonal Multiple Access Multiple Relays Channel) system described with respect to the prior art;

FIG. 2 is a diagram of a transmission cycle of a frame according to one exemplary implementation of the invention;

FIG. 3 is a diagram of the protocol of the exchanges of decoding control between the destination and the nodes, sources and relays, according to one embodiment of the invention;

FIG. 4 is a diagram of an embodiment of a base station according to the invention;

FIG. 5 is a diagram of an embodiment of a terminal according to the invention.

### DESCRIPTION OF PARTICULAR EMBODIMENTS

A channel use is the smallest time-frequency resource granularity defined by the system that allows a modulated symbol to be transmitted. The number of channel uses is related to the available frequency band and the transmission duration.

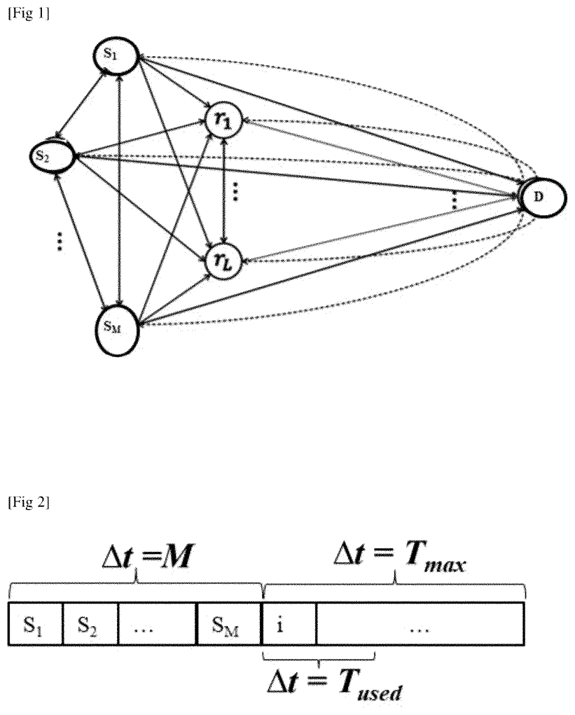

An OMAMRC telecommunication system is illustrated in FIG. 1, which has already been described.

A telecommunication system according to the invention comprises N nodes including M sources that belong to the set of sources [symbol] ={S₁, . . . , S_{M}}, and L=N−M relays, N≥M≥2, that belong to the set of relays [symbol] ={r₁, . . . , r_{L}} and a destination D. By convention, it is considered that Sᵢ=i∀i∈{1, . . . , M} and rᵢ=M+i∀i∈{1, . . . , L}; in other words, it is possible to confuse a source and its index, and a relay and its index (shifted from the value M of the number of sources). Each source of the set [symbol] communicates with the single destination with the assistance of the other sources (user cooperation) and the cooperating relays. The nodes, sources plus relays, are therefore indexed by j∈{1, . . . , M+L}.

### Transmission Cycle of a Frame According to the Invention

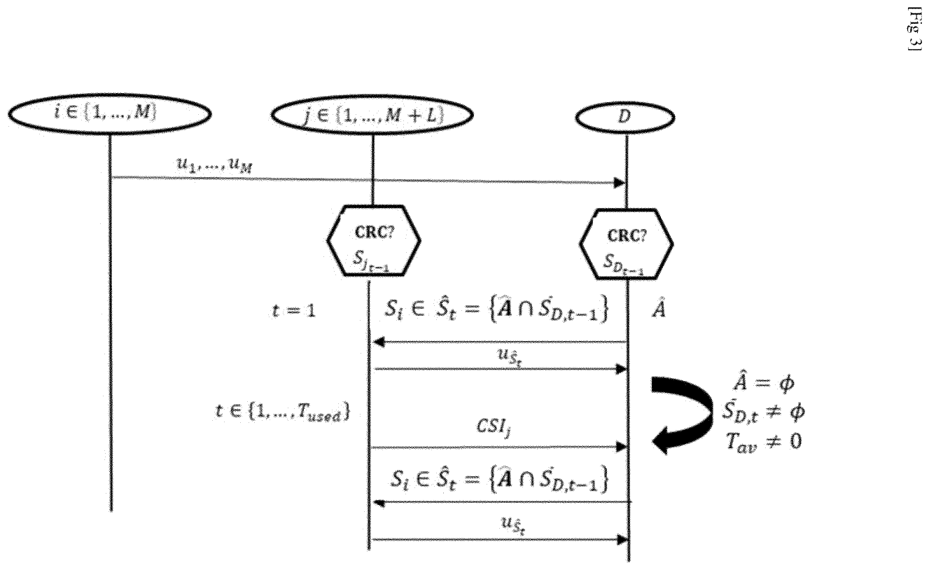

A transmission cycle of a frame according to one exemplary implementation of the invention is illustrated in FIG. 2.

The method according to the invention distinguishes two phases for each frame to be transmitted: a 1^{st} phase and a 2^{nd} phase. The transmission of a frame is optionally preceded by an additional phase, called initial phase, during which the rates Rᵢ, i∀i∈{1, . . . , M} are allocated.

The M sources access the transmission channel according to a time orthogonal multiple access scheme during the 1^{st} phase. During the 2^{nd} phase, access to the transmission channel of the N nodes that include the M sources and optionally the L relays is considered to be orthogonal because for each retransmission slot the active nodes transmit the same redundancy of the same message from the same source i at the same time.

The N nodes operate in a half-duplex mode that allows them to listen to the transmissions of the other nodes without any interference. The sources can act as a relay when they do not transmit only their own message.

The CSIs of the links are assumed to be constant (slow fading assumption) during the transmission of a frame. From time to time, the destination allocates rates to the sources knowing the statistical distribution of all the direct and indirect channels (CDI: Channel Distribution Information). It is assumed that the allocation of rates does not change for several hundred frames; it only changes with the changes in CDL

Each of the allocated rates unambiguously determines a modulation and coding scheme (MCS) and, conversely, each MCS determines a rate. The allocated rates are fed back from the destination to the sources via control channels with very limited rate (shown as dashed lines in FIG. 1).

By way of a simplification of the description, the following assumptions are subsequently made concerning the system:
the sources, the relays and the destination are equipped with a single transmit antenna (or transmit antenna port);
the sources, the relays and the destination are equipped with a single receive antenna (or receive antenna port);
the sources, the relays and the destination are perfectly synchronized;
the sources are statistically independent (there is no correlation between them);
all the nodes transmit with the same power;
a CRC code is used that is assumed to be included in the Kᵢ information bits of each source i in order to determine whether or not the message associated with the information bits is correctly decoded, i∈ [symbol] ,
the links between the various nodes experience additive noise and fading. The fading gains are fixed during the transmission of a frame carried out for a maximum duration of M+Tₘₐₓ time slots, but can change independently from one frame to another. Tₘₐₓ≥1 is a system parameter;
the instantaneous quality of the direct channel/link on reception (CSIR: Channel State Information at Receiver) is available to the destination, and in a known manner the destination estimates the direct channels and therefore their quality by exploiting, for example, the one or more reference signals received during the 1^{st} phase;
any feedback is error-free (no error on the control signals/channels).

The following notations are used:
Rᵢ=Kᵢ/N₁ is a discrete variable representing the rate of the source i provided by a link adaptation method implemented before transmitting frames;
T_{used} is the number of retransmission slots used during the 2^{nd} phase, T_{used} ∈{1, . . . , Tₘₐₓ}, and it corresponds to the number of transmissions during this phase;
α=N₂/N₁ is the ratio between the number of channel uses available for each time slot of the 2^{nd} phase and the number of channel uses available for each time slot of the 1^{st} phase;
S̅_{D,0} is the set of sources not correctly decoded by the destination at the end of the 1^{st} phase;
O_{i,l} is the fault indicator (outage) after l (l=0, . . . , nᵢ) retransmissions assisting the source i that assumes the value of one when an individual fault event occurs and the value of zero in the other cases. O_{i,n}ⁱ represents the fault event of the source i, i.e., the source is not correctly decoded after nᵢ retransmissions assisting this source;
I_{i,D} represents the mutual information between the source i∈{1, . . . , M} and the destination D;
J̅_{i,D}(l) is defined as the quality information for the equivalent channel between the nodes that decoded the same source i and the destination, based on knowledge of the fading of the direct channels and the indirect channels, for the l^{th} retransmission assisting the source i, i.e., knowing the nodes that decoded the source i after l−1 retransmissions assisting the same.

An equivalent channel for the source i is the result of a superposition (linear addition or combination) of the coefficients of the links of the nodes that decoded the source i to the destination. This is due to the fact that the nodes j∈A transmit the same signal RV at a near multiplicative coefficient αⱼ, where A is the subset of the nodes that decoded the source i and RV is the signal corresponding to an incremental redundancy of the message from the source i.

Thus, upon reception the channel can be expressed as:

$$( {\sum }_{j ∈ A} {a}_{j} {h}_{j , D} ) R V = {h}_{e q} R V$$

The multiplicative coefficients αⱼ can be equal, for example, to

$${α}_{j} = \frac{{h}_{j , D}^{*}}{\vert {h}_{j , D} \vert}$$

if each node j∈A is aware of the channel h_{j,D} on transmission. The equivalent channel becomes:

$${h}_{e q} = {\sum }_{j ∈ A} \vert {h}_{j , D} \vert$$

This technique is known by the term “Equal Gain Combining” and allows coherent addition of the fading of the links.

### Transmission of a Frame According to the Invention

FIG. 3 schematically illustrates the exchanges between all the nodes and the destination D accordin_{g} to one embodiment. The sources i∈ [symbol] intervene during the 1^{st} phase, and the sources and the relays j∈{1, . . . , M+L} intervene during the 2^{nd} phase.

During the first phase of the method, the sources i∈ [symbol] successively transmit after coding their message uᵢ comprising Kᵢ information bits uᵢ ∈

$${𝔽}_{2}^{{K}_{i}} ,$$

with [symbol] being the two-element Galois field. The message uᵢ comprises a CRC-type code that allows the integrity of the message uᵢ to be checked. The message uᵢ is coded according to the MCS determined by the allocated rate.

Given that the MCSs can be different between the sources, the lengths of the coded messages u₁, . . . , u_{M} can be different between the sources. The coding uses an incremental redundancy type code. The obtained codeword is segmented into successive redundancies. The incremental redundancy code can be of the systematic type, and the information bits are then included in the first redundancy. Whether or not the incremental redundancy code is of the systematic type, it is such that the first redundancy can be decoded independently of the other redundancies. The incremental redundancy type code can be generated, for example, by means of a finite family of rate compatible punctured linear codes or rateless codes modified to operate with finite lengths: raptor code (RC), rate compatible punctured turbo code (RCPTC), rate compatible punctured convolutional code (RCPCC), rate compatible low density parity check code (RCLDPC).

The transmission by a source conventionally comprises one or more reference signals. By exploiting these reference signals (pilot symbols, SRS signals of the 3GPP LTE, etc.), the destination can determine capacity information, in particular the gains (CSI: Channel State Information) of the direct links: h_{dir}={h_{S}_{₁}_{,D}, . . . , h_{S}_{_{M}}_{,D}}, i.e., source links to the destination, and thus can deduce therefrom the SNRs of these links and therefore their quality and their capacity.

Whether it is during the first phase or the second phase, when a node transmits, in particular a source, the destination and the other nodes listen.

The destination, the sources and the relays attempt to decode the received redundancies at the end of a time slot. The success of the decoding on each node is decided by using the CRC. The destination and nodes thus determine their set of sources correctly decoded for each time slot,

$${S}_{D , t - 1} {S}_{j , t - 1} .$$

The 2^{nd} transmission phase of the method comprises t={1, . . . , T_{used}} retransmission slots with the convention that t=0 corresponds to the last transmission slot of the first phase. The term retransmission associated with a slot is used in connection with the 2^{nd} phase to clearly indicate that any transmission during this phase of an n^{th} redundancy of the message from a source i occurs while this source i has already transmitted the 1^{st} redundancy of this same message during the 1^{st} phase.

According to the method, for each retransmission slot there is no exchange of decoding control between the destination and the nodes: on the one hand, the destination does not systematically feed back its set of correctly decoded sources for each retransmission slot nor any indication concerning correct or incorrect decoding, and, on the other hand, the nodes do not systematically transmit their set of correctly decoded sources for each retransmission slot nor any indication concerning the correct or incorrect decoding thereof.

At the beginning of the first phase the destination estimates, for the sources not yet correctly decoded, Sᵢ∈S̅_{D,0}, the numbers xᵢ of retransmission slots that are sufficient for the destination to decode these sources based on knowledge of the rates Rᵢ assigned to these sources and on at least the capacity information of the various direct channels between the sources and the destination.

According to a first embodiment, the sufficient numbers xᵢ of retransmission slots are estimated based on the rates Rᵢ and on only knowledge of fading of the various direct links between the sources and the destination. According to a second embodiment, estimating the sufficient numbers xᵢ of retransmission slots also takes into account knowledge of the sets of sources correctly decoded by the nodes at the end of the transmission phase by the destination. This information requires an exchange of correctly decoded sets of sources between the nodes and the destination at the end of the transmission phase.

These sufficient numbers xᵢ of retransmission slots limit the exact numbers of slots that are necessary and sufficient at the destination for decoding the sources not yet correctly decoded.

The set Â of sources to be assisted comprises, among the sources not yet correctly decoded, those or some of those that the destination is certain it can decode in the remaining time Tₐᵥ, knowing the sufficient numbers xᵢ of retransmission slots for decoding these sources.

The optimal set Â of sources to be assisted is the set of sources not yet decoded that optimizes spectral efficiency.

For each retransmission slot t, the destination broadcasts the number of the source i to be assisted from among the set Â of sources to be assisted.

For each retransmission slot t, and before selecting the number of a source to be assisted, the remaining number of retransmission slots Tₐᵥ is: Tₐᵥ=Tₘₐₓ−T_{used}.

For t=0, T_{used}=0, Tₐᵥ=Tₘₐₓ.

According to a first embodiment, the destination does not require any exchange of control at the end of the 1^{st} phase. The capacity of the channel between a node i, i∈{1, . . . , M}, and the destination is deduced from the quality of the channel, i.e., the mutual information I_{i,D} between this node i and the destination D. The sufficient number xᵢ of retransmission slots for decoding a source Sᵢ∈S̅_{D,0} from among the sources not yet correctly decoded by the destination is estimated based on the capacity information I_{i,D} of the direct channel between this source and the destination obtained from the transmission of this source that occurred during the 1^{st} phase:

$${x}_{i} = ⌈ \frac{{R}_{i} - {I}_{i , D}}{α {I}_{i , D}} ⌉ \qquad ( 1 )$$

According to the second embodiment, the destination requires an exchange of control at the end of the 1^{st} phase in order to obtain the sets of sources correctly decoded by the nodes for the retransmission slot t=0. At the end of the exchange of control, an equivalent channel is determined for each source i not yet correctly decoded. This considered equivalent channel consolidates the channels between each of the nodes with correct knowledge of the source i and the destination. The capacity of the equivalent channel is evaluated by the mutual information J̅_{i,D} (1) determined between all the nodes with correct knowledge of the source i and the destination. The sufficient number xᵢ of retransmission slots for decoding a source not yet correctly decoded Sᵢ∈S_{D,0} is estimated based on the capacity information of the direct channel between the source and the destination that is obtained from the transmission of this source that occurred during the 1^{st} phase and on the quality information J̅_{i,D} (1) of the equivalent channel between the nodes with correct knowledge of this same source and the destination determined based on the sets of sources correctly decoded by the nodes:

$${x}_{i} = ⌈ \frac{{R}_{i} - {I}_{i , D}}{α {\overline{J}}_{i , D} ( 1 )} ⌉ \qquad ( 2 )$$

Thus, according to this second embodiment, the nodes transmit their set of correctly decoded sources to the destination, or at least their set of sources correctly decoded sources and not yet correctly decoded by the destination, once only, i.e., at the end of the last transmission slot, t=0, or similarly at the beginning of the 1^{st} retransmission slot, t=1.

Subsequently, the mutual information J̅_{i,D} (1) is defined as the information concerning the quality of the equivalent channel between the nodes that decoded the same source i and the destination based on knowledge of the fading of the direct channels and of the indirect channels for the first retransmission assisting the source i, i.e., knowing the nodes that decoded the source i after the transmission phase.

The transmission by a node conventionally comprises one or more reference signals. In a known manner, the destination estimates the channel and therefore its quality or its capacity between each of the nodes and the destination by exploiting, for example, the one or more reference signals received for this slot. By exploiting these reference signals (pilot symbols, SRS signals of the 3GPP LTE, etc.), the destination can determine the gains (CSI: Channel State Information) of the direct links between the relays and the destination and can therefore deduce therefrom the average SNRs of these links therefrom and therefore their quality and capacity.

If the estimate of the xᵢ is such that for all the sources i∈{1, . . . , M}, the following inequality is met:

$${T}_{max} \geq {\sum }_{i ∈ {\overline{S}}_{D , 0}} {x}_{i} , \qquad ( 3 )$$

then all sources can be decoded without a conditional exchange. With all the sources being able to be correctly decoded by the destination within the remaining time, the method successively selects, for example, the sources to be assisted and does so randomly.

Knowing the sufficient numbers xᵢ of retransmission slots for decoding a source Sᵢ∈S̅_{D,0}, the destination determines the set Â of sources Sᵢ∈S̅_{D,0}, called sources to be assisted, not yet correctly decoded for which the sum of the sufficient numbers xᵢ of retransmission slots is less than or equal to Tₘₐₓ, Σ_{i∈A} xᵢ≤Tₘₐₓ, and, according to one embodiment, that maximize the spectral efficiency η^{frame}:

$$\hat{A} = {arg max}_{\begin{matrix}A ∈ P ( {\overline{S}}_{D , 0} ) \\ such that {\sum }_{i ∈ A} {x}_{i} \leq {T}_{max}\end{matrix}} \{ {η}^{f r a m e} = \frac{{\sum }_{i ∈ \{ {S}_{D , 0} ⋃ A \}} {R}_{i}}{M + α {\sum }_{i ∈ A} {x}_{i}} \}$$

The destination selects a source, called source to be assisted, for each retransmission slot by broadcasting the number i of the source taken from among the sources of the set Â, Sᵢ∈Â, via a control channel from the destination to the nodes. The nodes that correctly decoded this source then transmit the same redundancy u_{Ŝ}_{ₜ} of the message from this source during this retransmission slot using a data channel to assist the destination in correctly decoding this source.

As soon as the destination correctly decodes a source, it updates the set Â of sources to be assisted.

Irrespective of the embodiment, the method is particular in that it comprises a single conditional exchange of control of capacity information, CSIⱼ, in order to obtain capacity information concerning the indirect links and to determine a time, i.e., a necessary and sufficient number nᵢ of time slots, for decoding a source not yet correctly decoded:

$${n}_{i} = {arg min}_{n ∈ {ℕ}^{*}} \{ n \} such that : {R}_{i} \leq {I}_{i , D} + α {\sum }_{l = 1}^{n} {\overline{J}}_{i , D} ( l )$$

nᵢ is therefore the exact number of time slots for decoding a source Sᵢ not yet decoded, Sᵢ∈S̅_{D,t}, by the destination.

After the conditional exchange the destination redetermines the set Â of sources to be assisted. Knowing the necessary and sufficient numbers nᵢ of retransmission slots for decoding the sources Sᵢ∈S̅_{D,t}, based on the time slot t, the destination redetermines the set Â of sources, called sources to be assisted, not yet correctly decoded Sᵢ∈S̅_{D,t} for which the sum of the necessary and sufficient numbers nᵢ of retransmission slots is less than or equal to Tₘₐₓ, Σ_{i∈A} nᵢ≤Tₘₐₓ, and which, according to one embodiment, maximizes the spectral efficiency η^{frame}.

$$\hat{A} = {arg max}_{\begin{matrix}A ∈ P ( {\overline{S}}_{D , t} ) \\ such that {\sum }_{i ∈ A} {n}_{i} \leq {T}_{av}\end{matrix}} \{ {η}^{f r a m e} = \frac{{\sum }_{i ∈ \{ {S}_{D , t} ⋃ A \}} {R}_{i}}{M + α {\sum }_{i ∈ A} {n}_{i}} \}$$

with P(S̅_{D,t}) being the power set of S̅_{D,t}, i.e., all the possible sets of sources not yet correctly decoded and A being any set of P(S̅_{D,t}).

The exchange for obtaining the CSIⱼ occurs once. By conditioning this exchange, the method limits signaling overhead, while allowing the maximum number of sources to be decoded that provide a maximum total rate.

The destination requires this single conditional exchange of control of the capacity information CSIⱼ in order to obtain capacity information concerning the indirect links and to determine the necessary and sufficient time for decoding a source not yet correctly decoded:
either when the set of sources to be assisted is empty, Â=0, although the destination has not correctly decoded all the sources at the end of the 1^{st} phase, with the remaining time before the end of the transmission cycle of the frame being insufficient for decoding at least one source from among the sources not correctly decoded by the destination knowing the xᵢ of the sources remaining to be decoded;
or when sources to be decoded remain and when the destination has correctly decoded a source of the set Â of sources to be assisted without using all the sufficient retransmission slots of the initially determined number xᵢ.

The individual fault event of the source i O_{i,n}_{ᵢ}, can be expressed in the following form:

$${O}_{i , {n}_{i}} = \{ {R}_{i} > {I}_{i , D} + α {\sum }_{l = 1}^{{n}_{i}} {\overline{J}}_{i , D} ( l ) \}$$

This expression expresses the fact that the source i is not correctly decoded at the end of nᵢ retransmissions (assisting this source) if the rate Rᵢ of the source is greater than the sum of the transmission capacities. This transmission capacity includes the capacity of the channel between this source i and the destination that occurs during the 1^{st} phase and a sum weighted by α of the capacities of the equivalent channels that occur during the second phase.

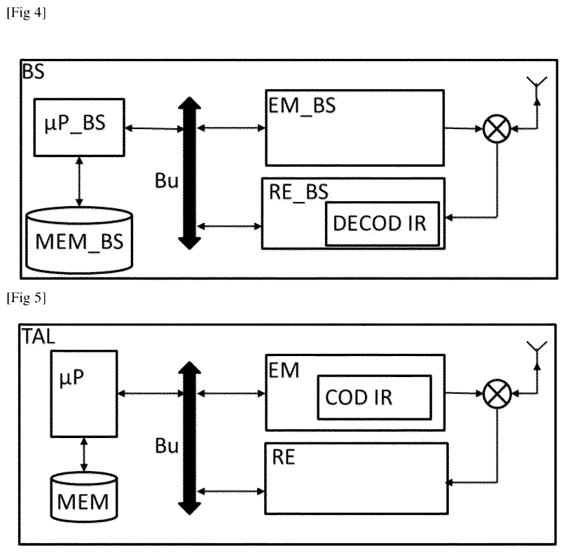

FIG. 4 is a diagram of the simplified structure of an embodiment of a base station BS according to one embodiment of the invention.

This base station is intended for a telecommunication system comprising N nodes including M sources Sᵢiϵ{1, . . . , M} and N−M relays, N≥M≥2, and a destination D, the base station BS corresponds to the destination. Access to the transmission channel between the nodes and the base station BS is of the orthogonal multiple access type. The protocol of the exchanges between the nodes and the base station BS defines a maximum number of M+Tₘₐₓ time slots per transmitted frame distributed between a 1^{st} phase of M time slots and a 2^{nd} phase of at least one time slot, called retransmission slot, 1≤Tₘₐₓ.

The base station BS comprises at least one microprocessor μP_BS whose operation is controlled by executing a program whose instructions allow a communication method according to the invention to be implemented, a memory MEM_BS, a transmitter EM_BS and a receiver RE_BS, which are connected to each other through a bus Bu. Of course, the constituent elements of the base station BS can be connected by means of a connection other than a bus.

The receiver RE_BS comprises at least one decoder DECOD IR for decoding received messages that have been coded according to incremental redundancy type coding that generates several redundancies. The decoder attempts to decode a message received from a source based on the 1^{st} redundancy. In the event of failure, the decoder jointly decodes this 1^{st} redundancy with the successive redundancies received during the retransmission slots reserved for this same source.

The microprocessor μP_BS controls the operations of the base station BS. The storage unit MEM_BS stores at least the program for implementing the method according to one embodiment of the invention to be executed by the processor μP_BS, and various data, such as parameters used for computations performed by the microprocessor μP, intermediate data of computations performed by the microprocessor μP, etc. The microprocessor μP_BS can be formed by any known and appropriate hardware or software, or by a combination of hardware and software. For example, the microprocessor μP_BS can be formed by dedicated hardware, such as a processing circuit, or by a programmable processing unit, such as a central processing unit that executes a program stored in a memory thereof.

The memory MEM_BS can be formed by any suitable means capable of storing the program or the programs and data in a microprocessor-readable manner. Examples of a memory MEM_BS include non-transitory storage media, such as semiconductor memory devices, and magnetic, optical, or magneto-optical storage media loaded into a read and write unit controlled by the microprocessor.

On initialization, the code instructions of the program are loaded, for example, into a buffer memory before being executed by the microprocessor μP_BS. The microprocessor μP_BS controls the various components of the base station BS.

Thus, by executing the instructions, the microprocessor μP_BS allows the base station BS to implement the communication method according to one embodiment of the invention, which comprises:
receiving, during the 1^{st} phase, M first redundancies of the M messages from the M sources, u₁, . . . , u_{M}, implemented by the receiver RE_BS;
transmitting the number of a selected source Sⁱ, called source to be assisted, not yet correctly decoded by the base station BS, implemented by the transmitter EM_BS for each retransmission slot of the 2^{nd} phase;
receiving, during the same retransmission slot of the 2^{nd} phase, the same second redundancy u_{Ŝt} of the same selected source Sᵢ and originating from various nodes with correct knowledge of this same source, implemented by the receiver RE_BS;
a conditional exchange of control with the nodes, during which the base station BS receives quality information of the indirect links CSIⱼ, implemented by the transmitter EM_BS and by the receiver RE_BS.

FIG. 5 is a diagram of the simplified structure of an embodiment of a terminal TAL according to one embodiment of the invention.

This terminal is intended for a telecommunication system comprising N nodes including M sources Sᵢ iϵ{1, . . . , M} and N−M relays, N≥M≥2, and a destination D, the terminal TAL corresponds to one of the sources. Access to the transmission channel between the nodes and the destination is of the orthogonal multiple access type. The protocol of the exchanges between the nodes and the destination defines a maximum number of M+Tₘₐₓ time slots per transmitted frame distributed between a 1^{st} phase of M time slots and a 2^{nd} phase of at least one time slot, called retransmission slot, 1≤Tₘₐₓ.

The terminal TAL comprises at least one microprocessor μP whose operation is controlled by executing a program whose instructions allow a communication method according to the invention to be implemented, a memory MEM, a transmitter EM and a receiver RE, which are connected to each other through a bus Bu. Of course, the constituent elements of the terminal TAL can be connected by means of a connection other than a bus.

The transmitter ER comprises at least one coder COD IR for coding messages according to incremental redundancy type coding that generates multiple redundancies for the same message to be coded.

The microprocessor μP controls the operations of the terminal TAL. The storage unit MEM stores at least the program for implementing the method according to one embodiment of the invention to be executed by the processor μP, and various data, such as parameters used for computations performed by the microprocessor μP, intermediate data of computations performed by the microprocessor μP, etc. The microprocessor μP can be formed by any known and appropriate hardware or software, or by a combination of hardware and software. For example, the microprocessor μP can be formed by dedicated hardware, such as a processing circuit, or by a programmable processing unit, such as a central processing unit that executes a program stored in a memory thereof.

The memory MEM can be formed by any suitable means capable of storing the program or the programs and data in a computer-readable manner. Examples of a memory MEM include non-transitory storage media, such as semiconductor memory devices, and magnetic, optical, or magneto-optical storage media loaded into a read and write unit controlled by the microprocessor.

On initialization, the code instructions of the program are loaded, for example, into a buffer memory before being executed by the microprocessor μP. The microprocessor μP controls the various components of the terminal TAL.

Thus, by executing the instructions, the microprocessor μP allows the terminal TAL to implement the communication method according to one embodiment of the invention.

The terminal TAL is able to transmit a framed message. Of course, the terminal TAL can successively transmit several messages. The communication method implemented by the terminal TAL is such that it comprises incremental redundancy type coding implemented by the coder COD IR of the transmitter EM that generates several redundancies of the same message to be transmitted. The transmission by the terminal TAL is of the time division multiplexing type.

The communication method implemented by the terminal TAL comprises:
transmitting a first redundancy of the message from the terminal to be transmitted during the 1^{st} phase, implemented by the transmitter EM;
receiving a source number Sᵢ indicating a selected source, called source to be assisted, not yet correctly decoded by the destination, implemented by the receiver RE;
transmitting, during a retransmission slot of the 2^{nd} phase, a second redundancy of the message from this selected source if the terminal TAL has correct knowledge of this source, implemented by the transmitter EM;
a conditional exchange of control with the destination, during which the terminal TAL transmits quality information of the indirect links of the terminal TAL with the other nodes, implemented by the transmitter EM and by the receiver RE.

### Examples of Particular Embodiments

The following description of an embodiment of the invention is illustrated with respect to implementation by an OMARC system with M=3 sources, S={1,2,3}, L=3 relays, R={4,5,6}, and a destination, and according to the example of a sequence of operations illustrated by the algorithm in Appendix B.

The parameter Tₘₐₓ is set to five.

The rates Rᵢ of the sources have the following values: R₁=1, R₂=2, R₃=3.

Â is the set of not correctly decoded sources that meets the condition concerning the sum of the numbers of retransmission slots that must be less than the remaining time and that results in the highest spectral efficiency η^{frame}.

According to the example, during the 2^{nd} phase, the selection, for each retransmission slot, of the source i to be assisted from among the set Â occurs according to the algorithm in Appendix B.

Step 1. At the end of the 1^{st} phase, or at the beginning of the 2^{nd} phase, i.e., t=1, the remaining time Tₐᵥ is set to Tₘₐₓ, the sets of sources correctly decoded by the nodes are as follows: S_{1,0}={1},S_{2,0}={2},S_{3,0}={3},R_{4,0}=0, R_{5,0}={2,3},R_{6,0}={1,2,3}, S_{D,0}=φ.

In other words, the sources 1, 2, 3 and the relay 4 have not yet correctly decoded anything at the end of the 1^{st} phase, but as a source knows its own message its set contains at least this message.

The relay 5 has correctly decoded the sources 2 and 3 and the relay 6 has correctly decoded the sources 1, 2 and 3 at the end of the 1^{st} phase. The destination D has not yet correctly decoded anything and therefore S̅_{D,0}={1,2,3}≠φ at the end of the 1^{st} phase.

Step 2. The destination estimates a number xᵢ of slots necessary for the destination to decode a source i that is not yet decoded, i∈S̅_{D,0}, based on knowledge of at least one mutual piece of information I_{i,D} of the source i destination link, of the direct channel, and of a rate Rᵢ assigned to this source i. Therefore, the destination computes xᵢ for any i∈S̅_{D,0}.

According to a first embodiment, only the mutual information of the source i destination link, of the direct channel, and of the rate Rᵢ is taken into account for computing xᵢ:

$${x}_{i} = {x}_{i} ( 0 ) = ⌈ \frac{{R}_{i} - {I}_{i , D}}{α {I}_{i , D}} ⌉ , i ∈ {\overline{S}}_{D , 0} = \{ 1 , 2 , 3 \}$$

For the example according to this first embodiment, the variables xᵢ have the following values:

$${x}_{1} = 4 , {x}_{2} = 3 , {x}_{3} = 3 .$$

According to a second embodiment, an exchange of control occurs with the nodes transmitting the set of sources thereof for which they have correct knowledge, namely S_{i,0}. The destination acknowledges the reception of the transmissions of the sources at the end of the 1^{st} phase. If the acknowledgement of receipt indicates that it has not correctly decoded all the sources, for example a control signal NACK, then the nodes transmit their set S_{i,0}, i∈S∪R={1,2,3,4,5,6}. The estimate of xᵢ can then take into account the mutual information of the source i destination link, of the direct channel, of the rate Rᵢ and mutual information J̅_{i,D}(1) of the equivalent channel between the nodes with correct knowledge of this source and the destination:

$${x}_{i} = {x}_{i} ( 0 ) = ⌈ \frac{{R}_{i} - {I}_{i , D}}{α {\overline{J}}_{i , D} ( 1 )} ⌉ , i ∈ {\overline{S}}_{D , 0} = \{ 1 , 2 , 3 \}$$

For the example, according to this second embodiment, the variables xᵢ have the following values:

$${x}_{1} = 3 , {x}_{2} = 2 , {x}_{3} = 3 .$$

Step 3. The destination determines the set Â of sources to be assisted from among the sources that it has not yet correctly decoded S̅_{D,0}. The set Â comprises the set of not yet correctly decoded sources that meets the condition concerning the number of remaining retransmission slots, i.e., each source of the set Â is decoded in the remaining time Tₘₐₓ (since t=0) and this results in the highest spectral efficiency η^{frame}.

According to the example, according to the first embodiment, the possible choices for Â that meet Σ_{i∈Â}≤Tₘₐₓ are: {1}, {2}, {3}. The criterion for the spectral efficiency per frame yields:

$${η}_{\{ 1 \}} = \frac{1}{3 + 4} = 1 / 7 , {η}_{\{ 2 \}} = \frac{2}{3 + 3} = 1 / 3 , {η}_{\{ 3 \}} = \frac{3}{3 + 3} = 1 / 2.$$

As η_{{1}}<η_{{2}}<η_{{3}}, then Â={3}.

According to the example, according to the second embodiment, the possible choices for Â that meet Σ_{i∈Â}xᵢ≤Tₘₐₓ are: {1},{2},{3},{1,2},{2,3}. The criterion for the spectral efficiency per frame yields:

$${η}_{\{ 1 \}} = \frac{1}{3 + 4} = 1 / 7 , {η}_{\{ 2 \}} = \frac{2}{3 + 3} = 1 / 3 , {η}_{\{ 3 \}} = \frac{3}{3 + 3} = 1 / 2 ,$$

$${η}_{\{ 1 , 2 \}} = \frac{1 + 2}{3 + 3 + 2} = 3 / 8 , {η}_{\{ 2 , 3 \}} = \frac{2 + 3}{3 + 2 + 3} = 5 / 8.$$

As η_{{1}}<η_{{2}}<η_{{3}}<η_{{1,2}}<η_{{2,3}}, then Â={2,3}.

Step 4. Setting the indicator of exchange of control of CSIⱼ to 0: Flag=0.

According to the example, according to the first embodiment and according to the second embodiment, for the current slot t=1 if no exchange of control of CSIⱼ has occurred then the destination sets the indicator to 0, i.e., Flag=0.

Step 5. If the set Â=0, i.e., no source can be assisted in the remaining time and if S̅_{D,t-1}≠φ, i.e., the destination has not been able to decode all the sources, then the method proceeds to step 6, otherwise the method proceeds to step 8.

According to the example, for each of the two embodiments, the condition Â=φ and S̅_{D,t}·φ is not verified, therefore the method proceeds to step 8.

Step 6. After an exchange of control of CSIⱼ to know the quality of the direct and indirect links, the method redetermines the set Â. To this end, the method proceeds according to the algorithm of Appendix A.

This determination of the set Â according to Appendix A is based on an exchange of control with the reception of the CSIⱼ of the indirect links, step 1 of the algorithm of Appendix A. The destination requests that the nodes transmit information related to the quality of the indirect channels. The indirect channels include all the channels between the sources, the channels between the relays and the channels between the sources and the relays, that is, all the channels between the nodes. From the transmissions that occurred during the 1^{st} phase and during the 2^{nd} phase, the destination can determine quality information of the direct channels, i.e., between the nodes and the destination. Therefore, the destination is aware of quality indicators of all the channels, i.e., direct and indirect.

Step 2 of the algorithm of Appendix A. Based on this knowledge, the destination determines, for each source i not yet correctly decoded, the necessary and sufficient number nᵢ of retransmission slots for correctly decoding this source i, based on knowledge of mutual information of the direct source i destination link, on mutual information of the equivalent channels (for a given source, a channel equivalent to the slot t is considered to be the aggregation of the channels between the nodes with correct knowledge of this same source for this slot t and the destination) and of the rate Rᵢ assigned to this source i. Therefore, the destination computes nᵢ for any i∈S̅_{D,t-1}. This number nᵢ is the smallest number n of retransmissions following which there is no decoding error, i.e., the rate Rᵢ of the source is less than or equal to the sum, on the one hand, of the capacity of the direct channel I_{i,D} and, on the other hand, of the sum

$${\sum }_{l = 1}^{n} {\overline{J}}_{i , D} ( l )$$

weighted by α of the equivalent channels for the n retransmission slots (assisting the source i).

Step 3 of the algorithm of Appendix A. The destination determines the set Â knowing the necessary and sufficient numbers nᵢ of time slots following which the sources are correctly decoded. The set Â comprises the set of sources not yet correctly decoded that results in the highest spectral efficiency η^{frame} and that meets the condition of the number of remaining retransmission slots, i.e., each source of the set Â is decoded in the remaining time. The destination jointly broadcasts, to the nodes and in the same order, the set Â and the necessary and sufficient numbers xᵢ=nᵢ of time slots of each source of the set Â.

Step 7. The destination updates the indicator of exchange of control of CSIⱼ, i.e., Flag=−1, to signify that an exchange has already occurred and to subsequently avoid another exchange of control of CSIⱼ by testing this indicator.

Step 8. End of the if of step 5.

Step 9. While there is still a source i to be assisted in the set Â, i.e., Â≠φ, the method proceeds with steps 10-38.

According to the example, according to the first embodiment, for t=1, Â={3}. Then, for t=4, Tₐᵥ=2, Â={2}(looping back from step 38 after redetermining Â between steps 17-20).

According to the example, according to the second embodiment, for t=1 Â={2, 3} and for t=3, Â={3}.

Step 10. Indicator test: if no exchange of CSIⱼ has taken place yet, the indicator is zero, and the method proceeds to step 11, otherwise the method proceeds to step 28 to process the case when an exchange of CSIⱼ has already taken place.

Step 11. For the retransmission slot t, the destination selects a source i of the set Â. When there are multiple sources in Â then the first selection of a source can be random or can, for example, follow an ascending or descending order of the xᵢ or of the source numbers.

According to the example, according to the first embodiment, for t=1, the destination selects the source 3. Then for t=4, the destination selects the source 2.

According to the example, according to the second embodiment, for t=1, the destination selects the source 2 and then for t=3 the destination selects the source 3.

Step 12. The method repeats steps 13-27 while the source i is not correctly decoded by the destination.

Step 13. The destination requests the assistance of the nodes for the source i. For each retransmission slot t the destination broadcasts, to the nodes, the number of the source i to be assisted by the nodes. The nodes with correct knowledge of this source i transmit the same redundancy for this same source i during the current retransmission slot t.

According to the example, according to the first embodiment, for t=1, for t=2 and for t=3, the destination broadcasts the number 3. For t=1, the nodes with correct knowledge of the source 3 transmit the same 2^{nd} redundancy of the message from the source 3 while considering that during the 1^{st} phase the source 3 has transmitted a 1^{st} redundancy of its message. Then, for t=2, the nodes with correct knowledge of the source 3 transmit the same 3^{rd} redundancy of the message from the source 3, and then for t=3 the same 4^{th} redundancy of the message from the source 3.

Then for t=4 and for t=5 the destination broadcasts the number 2. The nodes with correct knowledge of the source 2 transmit the same redundancy of the message from the source 2, i.e., a 2^{nd} redundancy for t=4 and a 3^{rd} redundancy for t=5 while considering that during the 1^{st} phase the source 2 has transmitted a 1^{st} redundancy of its message.

According to the example, according to the second embodiment, for t=1, then for t=2, the destination broadcasts the number 2. The nodes with correct knowledge of the source 2 transmit the same redundancy of the message from the source 2, i.e., a 2^{nd} redundancy for t=1 and a 3^{rd} redundancy for t=2 of the message from the source 2. Then, after the source 2 is correctly decoded, for t=3, for t=4 and for t=5, the destination broadcasts the number 3. The nodes with correct knowledge of the source 3 transmit the same redundancy of the message from the source 3, i.e., a 2^{nd} redundancy for t=3, a 3^{rd} redundancy for t=4 and a 4^{th} redundancy for t=5 of the message from the source 3.

Step 14. The method increments the value of the current retransmission slot, t←t+1.

According to the example, according to the first embodiment, for the 1^{st} loop (of step 12), i=3, t=1+1=2. When i=3, for the 2^{nd} loop (of step 12), t=2+1=3. Then, i=2, for the 1^{st} loop (of step 12) t=3+1=4 and for the 2^{nd} loop (of step 12), t=4+1=5 and the source i=2 is decoded during this 2^{nd} loop.

According to the example, according to the second embodiment, for the 1^{st} loop (of step 12), i=2, t=1+1=2. When i=2, for the 2^{nd} loop (of step 12), t=2+1=3 and the source i=2 is decoded during this 2^{nd} loop and the next source is selected in step 11. t=3+1=4 for the 1^{st} loop (of step 12) with i=3. When i=3, for the 2^{nd} loop (of step 12), t=4+1=5. When i=3, for the 3^{rd} loop (of step 12), t=5+1=6 and the source i=3 is decoded during this 3^{rd} loop.

Step 14. The method decrements the remaining time, Tₐᵥ←Tₐᵥ−1 and decrements the value of xᵢ, since i has been assisted once by the nodes.

According to the example, according to the first embodiment, when t←2, Tₐᵥ=Tₘₐₓ−1=4, x₃=2, then when t←3, Tav=3, x₃=1, then when t←4, Tₐᵥ=2, x₃=0. Then when t←5, Tₐᵥ=2−1=1, x₂=n=1, then when t←6, Tₐᵥ=0, x₂=0.

According to the example, according to the second embodiment, when t←2, Tₐᵥ=Tₘₐₓ−1=4, x₂=1, then when t←3, Tₐᵥ=3, x₂=0, then when t←4, Tₐᵥ=2, x3=2, then when t←5, Tₐᵥ=1, x₃=1, then when t←6, Tₐᵥ=0, x₃=0.

Step 15. If the destination has correctly decoded the source i for the slot t−1, then the method proceeds with steps 16-25, otherwise the method proceeds to step 26 and then 27 and optionally loops back to step 12.

According to the example, according to the first embodiment, when i=3, the source 3 is correctly decoded into three retransmission slots, since initially x₃=3. Therefore, while t−1<3 the method loops back to step 12.

When t=4, S_{D,3}={3}, then the method proceeds to step 16. Then, when i=2, the source 2 is correctly decoded into two retransmission slots, since x₂=n₂=2. Therefore, while t−1<5, the method loops back to step 12. When t=6, S_{D,5}={2,3}, then the method proceeds to step 16.

According to the example, according to the second embodiment, when i=2, the source 2 is correctly decoded into two retransmission slots, since initially x₂=2. Therefore, while t−1<2 the method loops back to step 12. When t=3, S_{D,2}={2}, then the method proceeds to step 16. Then, when i=3, the source 3 is correctly decoded into three retransmission slots, since x₃=3. Therefore, while t−1<5 the method loops back to step 12. When=6, S_{D,5}={2,3}, then the method proceeds to step 16.

Step 16. The source i correctly decoded for the slot t−1 is removed from the set Â and the method proceeds to step 17.

According to the example, according to the first embodiment, for t=4, the source i=3 is correctly decoded, then Â=Â\{3}=∅ and Tₐᵥ=2 and the method proceeds to step 17.

Then, for t=6, the source i=2 is correctly decoded, then Â=Â\{2}=∅ and Tₐᵥ=0 and the method proceeds to step 17.

According to the example, according to the second embodiment, for t=3, the source i=2 is correctly decoded, then Â=Â\{2}={3} and Tₐᵥ=3 and the method proceeds to step 17.

Then, for t=6, the source i=3 is correctly decoded, then Â=Â\{3}=∅ and Tₐᵥ=0 and the method proceeds to step 17.

Step 17. If sources still need to be decoded and there is still remaining time, then the method proceeds to steps 18-24, otherwise the method proceeds to step 25.

According to the example, according to the first embodiment, for t=4, S̅_{D,3}={1,2}≠∅ and Tₐᵥ=2, therefore, the method proceeds to step 18. Then, for t=6, S̅_{D,5}={1}≠∅, but Tₐᵥ=0, then the method proceeds to step 25.

According to the example, according to the second embodiment, for t=3, S̅_{D,2}={1,3}≠∅ and Tₐᵥ=3, therefore, the method proceeds to step 18. Then, for t=6, S̅_{D,5}={1}≠∅, but Tₐᵥ=0, then the method proceeds to step 25.

Step 18. If the source i has been decoded before the initially estimated time, i.e., xᵢ>0, then the method proceeds to step 19 and otherwise to step 20.

According to the example, according to the first embodiment, for t=4, x₃=0, i.e., the destination indeed needs the three slots in order to decode the source 3, therefore the method proceeds to step 20.

According to the example, according to the second embodiment, for t=3, x₂=0, i.e., the destination indeed needs the two slots in order to decode the source 2, therefore the method proceeds to step 20.

Step 19. The destination redetermines the set Â of sources to be assisted from among the sources that it has not yet correctly decoded S̅_{D,t-1} using the algorithm of Appendix A.

The set Â comprises the set of not yet correctly decoded sources that meets the condition of the number of remaining retransmission slots, i.e., each source of the set Â is decoded in the remaining time and which results in the highest spectral efficiency η^{frame}.

Step 20. End of the if of step 18.

Step 21. If the set Â of sources to be assisted is empty and no exchange of control of the qualities of the indirect links has yet taken place, i.e., flag=0, then the method proceeds to step 22 and otherwise to step 24.

According to the example, according to the first embodiment, for t=4, x₃=0, Â=0 and flag=0, then the method proceeds to step 22.

According to the example, according to the second embodiment, for t=3, i.e., A={3}#0, then the method proceeds to step 24.

Step 22. The destination determines the set Â. This determination takes place according to the algorithm in Appendix A, in the same way as in step 6.

According to the example, according to the first embodiment, for t=4, Tₐᵥ=2, the method redetermines the set Â. The destination computes xᵢ=nⱼ for any i∈S̅_{D,t-1}={1,2} knowing the quality of the indirect and direct channels. As in the example n₁=2, n₂=2 and R₁=1, R₂=2, then the source 2 results in better spectral efficiency, therefore Â={2}.

Step 23. The destination updates the indicator of exchange of control of CSIⱼ, i.e., Flag=−1, to signify that an exchange has already occurred and to subsequently avoid another exchange of control of CSIⱼ by testing this indicator.

Step 24. End of the if of step 21. The method proceeds to step 25.

Step 25. End of the if of step 17. The method proceeds to step 26.

Step 26. End of the if of step 15. The method proceeds to step 27.

Step 27. End of the while loop of step 12. The method loops back to step 12 while the source i is not correctly decoded and otherwise the method proceeds to step 38. According to the example, according to the first embodiment and according to the second embodiment, there is no exchange of CSIⱼ before step 10, the method proceeds to step 38.

Step 28. The case where Flag=−1 in step 10, i.e., an exchange of CSIⱼ already occurred before step 10. In this case, the method proceeds to steps 29-37.

Step 29. The nodes successively select the sources Ŝₜ, called sources to be assisted, in the set Â, in the order in which they appear in the set, one after the other.

Step 30. While for the selected source i the number xᵢ is not zero, the method proceeds to steps 31-36, i.e., the loop is covered xᵢ times for the source i.

Step 31. For each retransmission slot t, the nodes with correct knowledge of this source i transmit the same redundancy for this same source i during the current retransmission slot t.

Step 32. The method increments the value of the current retransmission slot, t←t+1.

The method decrements the remaining time, Tₐᵥ←Tₐᵥ−1 and decrements the value of xᵢ, since i has been assisted once by the nodes.

Step 33. If the source i has been decoded during the current retransmission slot, i.e., xᵢ=0 then the method proceeds to step 34 and otherwise to step 35.

Step 34. The correctly decoded source i is removed from the set Â, i.e., Â←Â\{i}.

Step 35. End of the if of step 33. The method proceeds to step 36.

Step 36. End of the while of step 30. If, for the selected source i, the number xᵢ is not zero, then the method loops back to step 30 and otherwise the method proceeds to step 37.

Step 37. End of the if of step 10.

Step 38. End of the while of step 9. The method loops back while sources still need to be assisted in the set Â, and otherwise Â=∅, the method is terminated, i.e., the transmission of the frame is interrupted, the method proceeds to the next frame.

According to the example, according to the first embodiment, for t=4 and Tₐᵥ=2, the method loops back to step 9, with Â={2}, (Tₐᵥ=2). Then, for t=6, S̅_{D,5}={1}≠∅, Â=∅, but Tₐᵥ=0, i.e., no other source can be decoded, it is the end of the transmission of the frame, the method proceeds to the next frame.

According to the example, according to the second embodiment, for t=3 and Tₐᵥ=3, the method loops back to step 9, with Â={3}. Then, for t=6, S̅_{D,5}={1}≠∅, Â=∅ and Tₐᵥ=0, i.e., no other source can be decoded, it is the end of the transmission of the frame, the method proceeds to the next frame.

According to the example, according to the first embodiment and according to the second embodiment, for t=6 the transmission of the frame is interrupted, there is a decoding fault (outage event) on the source 1.

According to another embodiment, the selection of a source in step 9 can occur randomly from among the sources of the set Â.
[1]S. Cerovi\grave{c}, R. Visoz, and L. Madier, “Efficient Cooperative HARQ for Multi-Source Multi-Relay Wireless Networks”, 2018, 11th International Workshop on Selected Topics in Wireless and Mobile Computing, IEEE, 2018.

### Appendix A

Determining the set A of sources that can be assisted:

TABLE 1
Computing_A_with_CSIⱼ

| | | | |
|---|---|---|---|
| 1. | \| | CSIⱼ | The nodes transmit the CSI via direct and |
| | \| | | indirect channels |
| 2. | \| | Destination computing nᵢ for any | The destination determines the necessary and |
| | \| | i ∈ S̅_{D,t-1} using | sufficient number nᵢ of retransmission slots for |
| | \| | nᵢ = [symbol] such that: | decoding the source i from among all the |
| | \| | ${R}_{i} \leq {I}_{i , D} + a {Σ}_{l = 1}^{n} {\overline{J}}_{i , D} ( l )$ | sources not yet correctly decoded i ∈ S̅_{D,t-1}, |
| | \| | | which corresponds to the smallest of the non- |
| | \| | | zero values of n, [symbol] , for which |
| | \| | | there is no decoding error (no outage) |
| | \| | | following the number n of retransmissions, |
| | \| | | i.e., such that the rate Rᵢ is less than or equal |
| | \| | | to the sum, on the one hand, of the capacity of |
| | \| | | the direct channel l_{i,D} and, on the other hand, |
| | \| | | $of the sum {Σ}_{l = 1}^{n} {\overline{J}}_{i , D} ( l ) weighted by α of the$ |
| | \| | | equivalent channels for the n retransmission |
| | \| | | slots |
| 3. | \| | Â ← argmax_{A∈P(}_̅{̅S̅}̅_{_{D,t−1}}₎ η^{^{frame}} | Â includes the ordered set of sources not yet |
| | \| | such that Σ_{i∈A} nᵢ ≤ Tₘₐₓ₋ₜ₊₁ | correctly decoded that results in the highest |
| | \| | | spectral efficiency η^{frame} and meets the |
| | \| | | condition of the number of remaining |
| | \| | | retransmission slots, i.e., Σ_{i∈A} nᵢ ≤ |
| | \| | | Tₘₐₓ₋ₜ₊₁ |
| 4. | \| | Â, xᵢ = nᵢ | The destination sends the ordered set Â of |
| | \| | | sources with the numbers xᵢ corresponding |
| | \| | | to retransmission slots for all the sources of |
| | \| | | the set Â |

### Appendix B

### Selection Strategy Algorithm:

TABLE 2

| 1. | | t ← 1, Tₐᵥ ← Tₘₐₓ | | | | | | Start of the 1^{st} transmission |
|---|---|---|---|---|---|---|---|---|
| | | | | | | | | phase, i.e., t is set to 1, |
| | | | | | | | | setting the remaining |
| | | | | | | | | number Tₐᵥ of |
| | | | | | | | | retransmission slots to Tₘₐₓ |
| 2. | | ${x}_{i} = ⌈ \frac{{R}_{i} - {I}_{i , D}}{α {I}_{i , D}} ⌉ for any i ∈ {\overline{S}}_{D , t - 1}$ | | | | | | Estimating the number xᵢ of retransmission slots for |
| | | | | | | | | decoding the source i based |
| | | | | | | | | on the CSIs of the direct |
| | | | | | | | | links only |
| 3. | | $\hat{A} ← {arg max}_{{A ∈ P ( {\overline{S}}_{D , t - 1} )}_{s . t . {\sum }_{i ∈ A} {x}_{i} \leq {T}_{av}}} {η}^{frame}$ | | | | | | Â includes the set of sources not correctly decoded resulting in the highest |
| | | | | | | | | spectral efficiency η^{frame} |
| | | | | | | | | and meeting the condition of |
| | | | | | | | | the sum of the numbers xᵢ |
| | | | | | | | | of retransmission slots less |
| | | | | | | | | than the remaining time |
| 4. | | Flag ← 0 | | | | | | Setting a flag to zero, i.e., |
| | | | | | | | | no exchange of control |
| | | | | | | | | requiring the transmission of |
| | | | | | | | | all the CSIⱼ has not yet |
| | | | | | | | | occurred |
| 5. | \| | If (Â = φ and S_{D,t-1} ≠ φ) then | | | | | | If no set of sources not |
| | \| | | | | | | | correctly decoded by the |
| | \| | | | | | | | destination meets the |
| | \| | | | | | | | condition of the sufficient |
| | \| | | | | | | | number of remaining slots, |
| | \| | | | | | | | i.e., Σ_{i∈A} xᵢ > Tₐᵥ, Â is |
| | \| | | | | | | | empty, then step 6. |
| 6. | \| | Computing_A_with_CSIⱼ | | | | | | Use the algorithm of |
| | \| | | | | | | | Appendix A to compute Â |
| | \| | | | | | | | by using an exchange of |
| | \| | | | | | | | control for receiving all the |
| | \| | | | | | | | CSIⱼ, for determining the |
| | \| | | | | | | | necessary and sufficient xᵢ |
| | \| | | | | | | | and then for sending Â and |
| | \| | | | | | | | xᵢ to the nodes |
| 7. | \| | Flag ← −1 | | | | | | Changing the value of the |
| | \| | | | | | | | flag, for example, setting the |
| | \| | | | | | | | flag to a negative value in |
| | \| | | | | | | | order to indicate that an |
| | \| | | | | | | | exchange of CSIⱼ has |
| | \| | | | | | | | occurred and thus |
| | \| | | | | | | | preventing more than one |
| | \| | | | | | | | exchange of control |
| | \| | | | | | | | requiring the transmission of |
| | \| | | | | | | | all the CSIⱼ |
| 8. | \| | End of if | | | | | | |
| 9. | \| | While (Â ≠ φ) then | | | | | | The transmission of the |
| | \| | | | | | | | frame is stopped (step 38) |
| | \| | | | | | | | when Â is empty, i.e., there |
| | \| | | | | | | | is no longer a source not |
| | \| | | | | | | | correctly decoded by the |
| | \| | | | | | | | destination that can be |
| | \| | | | | | | | decoded in the remaining |
| | \| | | | | | | | time |
| 10 | \| | \| | If (Flag = 0) then | | | | | If an exchange of control |
| | \| | \| | | | | | | has not yet occurred |
| | \| | \| | | | | | | involving the |
| | \| | \| | | | | | | communication of all the |
| | \| | \| | | | | | | CSIⱼ, then step 11, |
| | \| | \| | | | | | | otherwise step 28 (no other |
| | \| | \| | | | | | | source can be decoded in the |
| | \| | \| | | | | | | remaining time) |
| 11. | \| | \| | \| | Selecting a source i ∈ Â | | | | Random selection or |
| | \| | \| | \| | | | | | selection following an order, |
| | \| | \| | \| | | | | | by the destination, of a |
| | \| | \| | \| | | | | | source to be assisted from |
| | \| | \| | \| | | | | | among those of the set Â |
| 12. | \| | \| | \| | While (i ∉ S_{D,t-1}) then | | | | The source i is assisted until |
| | \| | \| | \| | | | | | it is decoded, steps 13-27 |
| 13. | \| | \| | \| | \| | D requests that the nodes assist the source | | | Following the request from |
| | \| | \| | \| | \| | i | | | the destination D, the nodes |
| | \| | \| | \| | \| | | | | that have correctly decoded |
| | \| | \| | \| | \| | | | | i transmit the same |
| | \| | \| | \| | \| | | | | redundancy at the same time |
| 14. | \| | \| | \| | \| | t ← t + 1, xᵢ ← xᵢ − 1, Tₐᵥ ← Tₐᵥ − 1 | | | Incrementing the current |
| | \| | \| | \| | \| | | | | round t, decrementing xᵢ, |
| | \| | \| | \| | \| | | | | since i has been assisted |
| | \| | \| | \| | \| | | | | once, decrementing the |
| | \| | \| | \| | \| | | | | remaining time Tₐᵥ |
| 15. | \| | \| | \| | \| | if (i ∈ S_{D,t-1}) then | | | If the destination has |
| | \| | \| | \| | \| | | | | correctly decoded the |
| | \| | \| | \| | \| | | | | assisted source i, then |
| | \| | \| | \| | \| | | | | proceed to step 16, |
| | \| | \| | \| | \| | | | | otherwise proceed to step 26 |
| 16. | \| | \| | \| | \| | Â ← Â\{i} | | | i is removed by the |
| | \| | \| | \| | \| | | | | destination from the set Â of |
| | \| | \| | \| | \| | | | | sources to be assisted |
| 17. | \| | \| | \| | \| | \| | if (S̅_{D,t-1} ≠ φ and Tₐᵥ ≠ 0) then | | If there are still sources to |
| | \| | \| | \| | \| | \| | | | decode and there is still |
| | \| | \| | \| | \| | \| | | | remaining time, then |
| | \| | \| | \| | \| | \| | | | proceed to step 18, |
| | \| | \| | \| | \| | \| | | | otherwise proceed to step 25 |
| 18. | \| | \| | \| | \| | \| | \| | if (xᵢ > 0) then | If all the time slots for |
| | \| | \| | \| | \| | \| | \| | | decoding i have not been |
| | \| | \| | \| | \| | \| | \| | | used, then proceed to step |
| | \| | \| | \| | \| | \| | \| | | 19, otherwise proceed to |
| | \| | \| | \| | \| | \| | \| | | step 20 |
| 19. | \| | \| | \| | \| | \| | \| | Recomputing Â as in step 3: | Recomputing Â using all |
| | \| \| \| | \| \| \| | \| \| \| | \| \| \| | \| \| \| | \| \| \| | $\hat{A} ← {arg max}_{{A ∈ P ( {\overline{S}}_{D , t - 1} )}_{s . t . {\sum }_{i ∈ A} {x}_{i} \leq {T}_{av}}} {η}^{frame}$ | the xᵢ, i.e., Â includes the sets of sources not correctly decoded resulting in the |
| | \| | \| | \| | \| | \| | \| | | highest spectral efficiency |
| | \| | \| | \| | \| | \| | \| | | η^{frame} and meeting the |
| | \| | \| | \| | \| | \| | \| | | condition of the number xᵢ |
| | \| | \| | \| | \| | \| | \| | | of retransmission slots less |
| | \| | \| | \| | \| | \| | \| | | than the remaining time |
| | \| | \| | \| | \| | \| | \| | | s.t. = provided that |
| 20. | \| | \| | \| | \| | \| | \| | End of if | |
| 21. | \| | \| | \| | \| | \| | \| | if (Â = φ and Flag = 0) then | If Â is empty and no |
| | \| | \| | \| | \| | \| | \| | | exchange of control for |
| | \| | \| | \| | \| | \| | \| | | receiving all the CSIⱼ has |
| | \| | \| | \| | \| | \| | \| | | occurred yet, then proceed |
| | \| | \| | \| | \| | \| | \| | | to step 22 and otherwise to |
| | \| | \| | \| | \| | \| | \| | | step 24 |
| 22. | \| | \| | \| | \| | \| | \| | Computing_A_with_CSIⱼ | Computing Â using an |
| | \| | \| | \| | \| | \| | \| | | exchange of control for |
| | \| | \| | \| | \| | \| | \| | | receiving all the CSIⱼ and |
| | \| | \| | \| | \| | \| | \| | | for determining the |
| | \| | \| | \| | \| | \| | \| | | necessary and sufficient xᵢ |
| | \| | \| | \| | \| | \| | \| | | and sending them to the |
| | \| | \| | \| | \| | \| | \| | | nodes, according to |
| | \| | \| | \| | \| | \| | \| | | Appendix A |
| 23. | \| | \| | \| | \| | \| | \| | Flag ← −1 | Setting the flag to a negative |
| | \| | \| | \| | \| | \| | \| | | value to indicate that an |
| | \| | \| | \| | \| | \| | \| | | exchange of CSIⱼ has |
| | \| | \| | \| | \| | \| | \| | | occurred and thus |
| | \| | \| | \| | \| | \| | \| | | preventing more than one |
| | \| | \| | \| | \| | \| | \| | | exchange of control |
| | \| | \| | \| | \| | \| | \| | | requiring the transmission of |
| | \| | \| | \| | \| | \| | \| | | all the CSIⱼ |

| | | | | | | | |
|---|---|---|---|---|---|---|---|
| 24. | \| | \| | \| | \| | \| | \| | End of if |

| | | | | | | |
|---|---|---|---|---|---|---|
| 25. | \| | \| | \| | \| | \| | End of if |

| 26. | \| | \| | \| | \| | End of if | |
|---|---|---|---|---|---|---|
| 27. | \| | \| | \| | End of while | | |
| 28. | \| | \| | Other | | | If an exchange of control |
| | \| | \| | | | | involving transmission of all |
| | \| | \| | | | | the CSIs has already |
| | \| | \| | | | | occurred, then proceed to |
| | \| | \| | | | | step 29, otherwise proceed |
| | \| | \| | | | | to step 37 |
| 29. | \| | \| | | The nodes successively select the sources from | | The nodes assist the sources |
| | \| | \| | | the ordered set Â: i ← 1^{st} element of Â | | i ∈ Â, xᵢ times according to |
| | \| | \| | | | | the order provided by Â |
| 30. | \| | \| | \| | While (xᵢ > 0) then | | The source xᵢ is assisted xᵢ |
| | \| | \| | \| | | | times |
| 31. | \| | \| | \| | | The nodes assist the source i | The nodes that have |
| | \| | \| | \| | | | correctly decoded i transmit |
| | \| | \| | \| | | | the same redundancy at the |
| | \| | \| | \| | | | same time |
| 32. | \| | \| | \| | | t ← t + 1, xᵢ ← xᵢ − 1 | Incrementing the current |
| | \| | \| | \| | | | round t, decrementing xᵢ |
| | \| | \| | \| | | | since i has been assisted |
| | \| | \| | \| | | | once |
| 33. | \| | \| | \| | \| | if (xᵢ = 0) then | If i has been assisted xᵢ |
| | \| | \| | \| | \| | | times at the end of the |
| | \| | \| | \| | \| | | preceding round, then step |
| | \| | \| | \| | \| | | 34, otherwise step 35 |
| 34. | \| | \| | \| | \| | Â ← Â\{i} | The nodes remove i from |

| | | | | |
|---|---|---|---|---|
| \| | \| | \| | \| | the set Â of sources to be |
| \| | \| | \| | \| | assisted, at the end of xᵢ the |
| \| | \| | \| | \| | destination has correctly |
| \| | \| | \| | \| | decoded the source i |

| | | | | | |
|---|---|---|---|---|---|
| 35. | \| | \| | \| | \| | End of if |

| | | | | |
|---|---|---|---|---|
| 36. | \| | \| | \| | End of while |

| | | | |
|---|---|---|---|
| 37. | \| | \| | End of if |

| | | |
|---|---|---|
| 38. | \| | End of while |

1. A communication method with transmission of a frame conveying at least one message in a telecommunication system comprising N nodes including M sources (Sᵢ iϵ{1, . . . , M}) and N−M relays, N≥M≥2, and a destination, the nodes operating in half-duplex mode, with orthogonal multiple access to a transmission channel between the N nodes and the destination, with a maximum number of M+Tₘₐₓ time slots per transmitted frame distributed between a 1ₛₜ phase and a 2_{nd} phase, with the message from a source having been coded before transmission according to incremental redundancy type coding that generates several redundancies, the 1^{st} phase includes M slots respectively allocated to successive transmissions of M initial redundancies of the M messages from the M sources and the 2^{nd} phase includes at least one retransmission slot for a transmission from nodes with correct knowledge of the same source (Sᵢ), such that these nodes simultaneously transmit the same redundancy of the message from the same source not yet correctly decoded by the destination during the same retransmission slot, with the transmission channel encompassing transmission channels, called direct channels, between the nodes and the destination and the transmission channels, called indirect channels, between the nodes with a remaining time being set during the 2^{nd} phase to Tₘₐₓ and a set Â of sources (Sᵢ) not yet correctly decoded being determined, taking into account numbers (xᵢ) of retransmission slots so that the destination can decode these sources in the remaining time, with the sources (Sᵢ), called sources to be assisted, of the set Â being such that a sum of the number of retransmission slots thereof is less than or equal to the remaining time, wherein the method is implemented by the destination and comprises:
determining numbers (xᵢ) of retransmission slots based on knowledge of rates (Rᵢ) assigned to the sources (Sᵢ) and on at least quality information of the various direct channels between the sources and the destination obtained from the transmissions that occurred during the 1^{st} phase, with these determined numbers (xᵢ) of slots being at least sufficient for the destination to decode these sources;
receiving redundancies transmitted by the nodes with correct knowledge of the sources to be assisted, during the determined numbers (xᵢ) of slots, so that the destination decodes these sources, and updating the remaining time after each retransmission slot; and
subject to the set Â being empty and to at least one not correctly decoded source remaining and the remaining time being non-zero, determining numbers (xᵢ) of retransmission slots based on knowledge of the rates Rᵢ assigned to these sources (Sᵢ) and on knowledge of a quality (CSIⱼ) of the various direct transmission channels and of the various indirect transmission channels, with these determined numbers (xᵢ) of slots being necessary and sufficient for the destination to decode the sources i not yet correctly decoded, and updating the set Â while taking into account the necessary and sufficient numbers (xᵢ) of slots.

2. The method as claimed in claim 1, wherein the sources (Sᵢ) of the set Â are those that maximize spectral efficiency.

3. The method as claimed in claim 1, wherein the method comprises:
broadcasting, to the N nodes for each retransmission slot, an identifier of sources (Sᵢ) taken from the set Â and doing so a number of times that is equal to the determined number (xᵢ) of slots for the identified source.

4. The method as claimed in claim 3, wherein the broadcast identifier of sources (Sᵢ) is randomly selected from the sources of the set Â.

5. The method as claimed in claim 1, further comprising a comparison between the numbers of retransmission slots of the sources of the set Â so that the broadcast identifier of sources (Sᵢ) is selected while taking into account a scheduling for these numbers of retransmission slots.

6. The method as claimed in claim 1, wherein the method comprises:
broadcasting, to the N nodes and in an ordered form, the set Â and the numbers of retransmission slots of the sources of the set.

7. The method as claimed in claim 1, wherein the method comprises:
broadcasting a request to the N nodes notifying them to transmit quality information of the channels, called indirect channels, between the nodes;
receiving quality information (CSIⱼ) of the indirect channels.

8. The method as claimed in claim 1, wherein, if the correct decoding of a source occurs before the end of the at least sufficient number of retransmission slots then the method updates the set Â.

9. The method as claimed in claim 1, wherein determining the at least sufficient numbers of retransmission slots is also based on the nodes transmitting their set of correctly decoded sources at the beginning of the 2^{nd} phase.

10. The method as claimed in claim 1, wherein, during an exchange of control with the nodes at the beginning of the 2^{nd} phase, the destination sends its set of correctly decoded sources and the nodes send their set of sources correctly decoded and not yet correctly decoded by the destination and wherein determining the at least sufficient numbers of retransmission slots is also based on the nodes transmitting their set of sources correctly decoded and not yet correctly decoded by the destination.

11. The method as claimed in claim 1, wherein, in response to no source being able to be assisted in the remaining time before the end of the 2^{nd} phase, then interrupting the transmission of the frame before using the maximum number of retransmission slots (T_{used}<Tₘₐₓ).

12. A communication method with transmission of a frame conveying at least one message implemented by a telecommunication device in a telecommunication system comprising N nodes including M sources (Sᵢ iϵ{1, . . . , M}) and N−M relays, N≥M≥2, and a destination, the device forming one of the sources, the nodes operating in half-duplex mode, with orthogonal multiple access to a transmission channel between the N nodes and the destination, with a maximum number of M+Tₘₐₓ time slots per transmitted frame distributed between a 1^{st} phase and a 2^{nd} phase, with the message from a source having been coded before transmission according to incremental redundancy type coding that generates several redundancies, the 1^{st} phase includes M slots respectively allocated to successive transmissions of M initial redundancies of the M messages from the M sources and the 2^{nd} phase includes at least one retransmission slot for a transmission from nodes with correct knowledge of the same source (Sᵢ), such that these nodes simultaneously transmit the same redundancy of the same message from the same source not yet correctly decoded by the destination during the same retransmission slot, with the transmission channel encompassing transmission channels, called direct channels, between the nodes and the destination and the transmission channels, called indirect channels, between the nodes with a remaining time being set during the 2^{nd} phase to Tₘₐₓ and a set Â of sources (Sᵢ) not yet correctly decoded being determined, taking into account numbers (xᵢ) of retransmission slots so that the destination can decode these sources in the remaining time, with the sources (Sᵢ), called sources to be assisted, of the set Â being such that a sum of the number of retransmission slots thereof is less than or equal to the remaining time, wherein the method comprises:
transmitting a first redundancy of a message from the device during the 1^{st} phase;
transmitting, during a retransmission slot of the 2^{nd} phase, a second redundancy of the message from a source of the set Â in response to the device having correct knowledge of this source;
conditional exchange of control with the destination, during which the device transmits quality information of the indirect links of the device with the other nodes.

13. A telecommunication device for transmitting a frame conveying at least one message in a telecommunication system comprising N nodes including M sources (Sᵢ iϵ{1, . . . , M}) and N−M relays, N≥M≥2, and a destination, the nodes operating in half-duplex mode, with orthogonal multiple access to a transmission channel between the N nodes and the destination, with a maximum number of M+Tₘₐₓ time slots per transmitted frame distributed between a 1^{st} phase and a 2^{nd} phase, with the message from a source having been coded before transmission according to incremental redundancy type coding that generates several redundancies, the 1^{st} phase includes M slots respectively allocated to successive transmissions of M initial redundancies of the M messages from the M sources and the 2^{nd} phase includes at least one retransmission slot for a transmission from nodes with correct knowledge of the same source (Sᵢ), such that these nodes simultaneously transmit the same redundancy of the same message from the same source not yet correctly decoded by the destination during the same retransmission slot, with the transmission channel encompassing transmission channels, called direct channels, between the nodes and the destination and the transmission channels, called indirect channels, between the nodes with a remaining time being set during the 2^{nd} phase to Tₘₐₓ and a set Â of sources (Sᵢ) not yet correctly decoded being determined, taking into account numbers (xᵢ) of retransmission slots so that the destination can decode these sources in the remaining time, with the sources (Sᵢ), called sources to be assisted, of the set Â being such that a sum of the number of retransmission slots thereof is less than or equal to the remaining time, wherein the device corresponds to one of the sources and comprises:
at least one microprocessor, a memory, a transmitter and a receiver, the transmitter comprising a coder implementing incremental redundancy type coding that generates several redundancies of the same message to be transmitted, wherein:
the transmitter is adapted to transmit a first redundancy of a message from the device during the 1^{st} phase;
the transmitter is also adapted to transmit, during a retransmission slot of the 2^{nd} phase, a second redundancy of the message from a source of the set Â in response to the device having correct knowledge of this source; and
the transmitter and the receiver are adapted for a conditional exchange of control with the destination, during which the device transmits quality information of the indirect links of the device with the other nodes.

14. A base station for a telecommunication system comprising N nodes including M sources (Sᵢ iϵ{1, . . . , M}) and N−M relays, N≥M≥2, and a destination, the nodes operating in half-duplex mode, with orthogonal multiple access to a transmission channel between the N nodes and the destination, with a maximum number of M+Tₘₐₓ time slots per transmitted frame distributed between a 1st phase and a 2^{nd} phase, with the message from a source having been coded before transmission according to incremental redundancy type coding that generates several redundancies, the 1^{st} phase includes M slots respectively allocated to successive transmissions of M initial redundancies of the M messages from the M sources and the 2nd phase includes at least one retransmission slot for a transmission from nodes with correct knowledge of the same source (Sᵢ), such that these nodes simultaneously transmit the same redundancy of the same message from the same source not yet correctly decoded by the destination during the same retransmission slot, with the transmission channel encompassing transmission channels, called direct channels, between the nodes and the destination and the transmission channels, called indirect channels, between the nodes with a remaining time being set during the 2^{nd} phase to Tₘₐₓ and a set Â of sources (Sᵢ) not yet correctly decoded being determined, taking into account numbers (xᵢ) of retransmission slots so that the destination can decode these sources in the remaining time, with the sources (Sᵢ), called sources to be assisted, of the set Â being such that a sum of the number of retransmission slots thereof is less than or equal to the remaining time, wherein the base station corresponds to the destination and comprises;
a decoder, a transmitter, a receiver, a microprocessor, such that:
during the 1^{st} phase the receiver is configured to successively receive the M first redundancies (u₁, . . . , u_{M}) of the M messages from the M sources;
the microprocessor is configured to determine numbers (xᵢ) of retransmission slots based on knowledge of rates (Rᵢ) assigned to the sources (Sᵢ) and on at least quality information of the various direct channels between the sources and the destination obtained from the transmissions that occurred during the 1^{st} phase, with these determined numbers (xᵢ) of slots being at least sufficient for the destination to decode these sources;
the receiver is able-configured to receive redundancies transmitted by the nodes with correct knowledge of the sources to be assisted, during the determined numbers (xᵢ) of slots, so that the base station (BS) decodes these sources;
the microprocessor is also configured to update the remaining time after each retransmission slot;
the microprocessor is also configured to determine numbers (xᵢ) of retransmission slots, subject to the set Â being empty and to at least one not correctly decoded source remaining and the remaining time being non-zero, based on knowledge of the rates Rᵢ assigned to these sources (Sᵢ) and on knowledge of a quality (CSIⱼ) of the various direct transmission channels and of the various indirect transmission channels, with these determined numbers (xᵢ) of slots being necessary and sufficient for the destination to decode the sources i not yet correctly decoded, and to update the set Â while taking into account necessary and sufficient numbers of slots.

15. A telecommunication system comprising N nodes including M sources (Sᵢ iϵ{1, . . . , M}) and N−M relays, N≥M≥2, and the base station according to claim 14, which corresponds to the destination.
